(19) United States
(12) Patent Application Publication
(10) Pub. No.: US 2022/0245437 A1
(43) Pub. Date: Aug. 4, 2022

(54) THREE-DIMENSIONAL NEUROMORPHIC DEVICE HAVING MULTIPLE SYNAPSES PER NEURON

(71) Applicant: Industry-University Cooperation Foundation Hanyang University, Seoul (KR)

(72) Inventors: Yun Heub SONG, Busan (KR); Jo Won LEE, Seoul (KR)

(73) Assignee: Industry-University Cooperation Foundation Hanyang University (IUCF-HYU), Seoul (KR)

(21) Appl. No.: 17/622,893

(22) PCT Filed: Jun. 26, 2020
(86) PCT No.: PCT/KR2020/008354

§ 371 Date: Dec. 27, 2021

(30) Foreign Application Priority Data
Aug. 21, 2019 (KR) 10-2019-0102158

(51) Int. Cl. G06N 3/063

(52) U.S. Cl. CPC G06N 3/063

(57) ABSTRACT

Disclosed is a three-dimensional neuromorphic device having multiple synapses per neuron, which includes a common gate that implements a single axon, and a plurality of data storage elements that implements each of a plurality of synapses, and the plurality of data storage elements have different physical structures.

### TECHNICAL FIELD

The present disclosure relates to a three-dimensional neuromorphic device that mimics a neuron composing a human nervous system.

### BACKGROUND ART

Neurons composing the human nervous system are constituted of one axon and about 1,000 to 10,000 synapses. A synapse is a junction between a pre-neuron and a post-neuron, and refers to a region where an axon of the pre-neuron that provides information (data) is connected to a dendrite of the post-neuron that receives the information. That is, the signal fired from a soma of the pre-neuron passes through the axon and meets the dendrites of thousands or more post-neurons at thousands of axon terminals to form the synapses.

In these synapses, data are stored and processed in parallel, and thousands or more of synapses are each connected to post-neurons with different weights. In this case, the weight refers to the strength of the connection between the pre-neuron and the post-neuron. This means that the input signal received through the pre-neuron is distributed and stored (i.e., a multi-valued synaptic weight) in synapses with multiple weights according to the characteristics of the signal.

Neurons having such characteristics may be mimicked as neuromorphic devices made of semiconductor devices at a nano level, and the human nervous system composed of neurons may be mimicked as an artificial neural network composed of neuromorphic devices.

The information processing adopted by most current neuromorphic devices is based on algorithms applied to existing artificial neural networks, such as a Deep Neural Network (DNN) and a Convolutional Neural Network (CNN). The artificial neural network is an algorithm implemented by focusing on the neural network of the human or animal brain, which is composed of a network in which a number of neurons are connected, and has a structure with tens to hundreds of hidden layer neurons in order to ensure the accuracy of an output value between input layer neurons and output layer neurons. The artificial neural network is a form in which several neurons are connected by a weighted link, uses the weighted link as the synapse and may implement a function to adjust the weight to adapt to a given environment.

Unlike the brain, where a feedback is the basic operating mechanism, the artificial neural networks take a feedforward method called a recognition pass. When the recognition result is different from the correct answer, the artificial neural network applies an algorithm called an Error Backpropagation that propagates the error in the reverse so as to correct the error. Through the application of the above algorithm, the calculation is repeated until the error is corrected and an expected value is obtained. As a result, the power consumption is relatively large. In addition, algorithms such as the DNN and the CNN applied to learning of most neuromorphic devices are algorithms of supervised learning, in which specific information is arbitrarily assigned to a specific neuron, and the allocated information is trained in the corresponding neuron. However, the brain is adopting unsupervised learning.

In general, in order to mimic memory devices as synapses to enable parallel storage and processing of data similar to biological neurons, first, the memory devices should exhibit non-volatile characteristics, and second, the memory devices should be able to have multi-valued memory states. Moreover, thirdly, for data processing, it is preferable that the multi-valued memory states have linearity.

Accordingly, the conventional neuromorphic devices implement a parallel information storage and processing method of biological neuron data, by using an FET (Field Effect Transistor) based CMOS transistors as the neuron, and by using nano-level nonvolatile memories such as a flash memory, a phase change memory (PCM), a ferroelectric random access memory (FRAM), a resistive random access memory (RRAM), and a conductive-bridge random access memory (CBRAM), which have three terminals, and a non-volatile cross-bar memory in the form of metal-insulator-metal (phase change materials and resistance change materials are used as insulators), which has two terminals as the synapse.

As such, the biggest problem of the conventional neuromorphic devices developed so far is that one neuron does not have thousands of synapses like a real brain, regardless of whether it is structurally the two terminals or the three terminals. In other words, unlike biological neurons, since the conventional neuromorphic devices have a cell structure that forms only one synapse per neuron, it has a structure that cannot operate like the biological neuron. Also, the RRAM, the PCM, the CBRAM, the FRAM, the flash memory, etc. may implement multi-valued weights as multiple conductance states or multiple resistance states, by applying different pulses to each cell and creating multiple conductance states or multiple resistance states with linearity.

However, in the case of a technology that implements the multi-valued weights by applying different pulses to each cell, it has the disadvantage that it is very difficult to accurately control each cell. Fundamentally, the architecture of this technology has a limitation in that it is not a cell structure that can obtain multi-valued synaptic weights through one axon per neuron like the biological neuron. That is, each cell has only one synapse, and since weight is given using one synapse, there is a problem in that data cannot be stored and processed in parallel.

In addition, since the conventional neuromorphic devices have a structure that controls a channel with one voltage in the case of a two-terminal structure, there is a limitation that the two functions of signal transmission and learning do not occur at the same time but are performed sequentially, unlike a three-terminal structure. Furthermore, due to the nonlinearity of the two-terminal structure, when it is applied to algorithms such as the DNN as hardware H/W, there are disadvantages in that excessive power is consumed to increase the recognition rate, and there are disadvantages in that it has a long latency time in which recognition functions (recognition/inference) cannot be processed in real time. Moreover, artificial intelligence systems currently implemented based on the two-terminal structure have a problem in that the cognitive function is inferior to that of mice with an IQ of 30 that even perform recognition and inference.

In the case of the conventional neuromorphic devices, since a minimum area of 6F² or more of a unit cell is required by adopting a planar structure in the case of the three-terminal structure, high integration is difficult due to the scaling limit of a unit device.

On the other hand, the artificial intelligence system based on a conventional neuromorphic devices has a disadvantage in that memory enhancement or forgetting is impossible because new information is compared with previously stored information, such as a human brain. In an attempt to overcome this, research to apply an RNN (Recurrent Neural Network) which is an autonomous learning algorithm to an FPGA (Field Programmable Gate Array), and an SNN (Spiking Neural Network) by a STDP (Spike Time Dependent Plasticity), which is the working mechanism of the brain, have been proposed. However, to date, no research has demonstrated the feedback function like humans.

Accordingly, there is a need to propose a technique for solving the limitations, disadvantages and problems of the conventional neuromorphic devices.

### DETAILED DESCRIPTION OF THE INVENTION

### Technical Problem

To overcome the limitations, disadvantages and problems of the conventional neuromorphic device described above, embodiments propose a three-dimensional neuromorphic device that stores and processes data to which a plurality of weights are assigned in parallel, by mimicking a single axon and a plurality of synapses like a biological neuron.

In particular, the embodiments propose a three-dimensional neuromorphic device that implements a single axon with a common gate and implements a plurality of synapses with a plurality of data storage elements, and allows the plurality of data storage elements to have different weights, by forming the plurality of data storage elements in different physical structures.

In addition, the embodiments propose a technique in which a three-dimensional neuromorphic device used as a post-neuron has a feedback function like a biological post-neuron while the three-dimensional neuromorphic device is used as a pre-neuron and a post-neuron, respectively.

### Technical Solution

According to an embodiment, a three-dimensional neuromorphic device having multiple synapses per neuron includes a common gate that implements a single axon, and a plurality of data storage elements that implements each of a plurality of synapses, and the plurality of data storage elements have different physical structures.

According to an embodiment, the plurality of data storage elements may have different weights through the different physical structures.

According to another embodiment, the plurality of data storage elements having the different weights may store and process data to which a plurality of weights are assigned in parallel, in response to a signal flowing through the common gate.

According to another embodiment, the plurality of data storage elements may have the different physical structures by being formed of different thicknesses or of different composition materials.

According to another embodiment, each of the plurality of data storage elements may be a nitride layer of ONO (Oxide layer-Nitride layer-Oxide layer) in a flash memory.

According to another embodiment, the plurality of nitride layers may have different amounts of charge depending on having different capacitance values through different physical structures.

According to another embodiment, each of the plurality of data storage elements may be a Mott insulator layer of OMO (Oxide layer-Mott insulator layer-Oxide layer) in a Mott memory.

According to another embodiment, the plurality of Mott insulator layers may have different conductivities or different resistance values, depending on having different phase transition characteristics (Insulator-to-Metal Phase Transition: Mott Transition) through different physical structures.

According to another embodiment, each of the plurality of data storage elements may be a phase change material (PCM) layer in a phase change memory

According to another embodiment, the plurality of PCM layers may have different resistance values depending on having different phase change characteristics through different physical structures.

According to another embodiment, each of the plurality of data storage elements may be an oxide layer in a resistance change memory.

According to another embodiment, the plurality of oxide layers may have different resistance values or different conductance values depending on having different resistances or different conductance change characteristics through different physical structures.

According to another embodiment, the three-dimensional neuromorphic device may be used as a pre-neuron and a post-neuron connected through at least one synapse of the pre-neuron and the plurality of synapses.

According to another embodiment, the three-dimensional neuromorphic device used as the pre-neuron, when it is necessary to store the same data as previously stored data in the plurality of data storage elements included in the three-dimensional neuromorphic device used as the pre-neuron, may perform only an output function in response to the three-dimensional neuromorphic device used as the post-neuron connected through the plurality of data storage elements being switched off.

According to another embodiment, the three-dimensional neuromorphic device used as the pre-neuron, when it is necessary to delete weighted data stored in the plurality of data storage elements included in the three-dimensional neuromorphic device used as the pre-neuron, may delete the weighted data stored in the plurality of data storage elements, in response to a backward pulse as the three-dimensional neuromorphic device used as the post-neuron connected through the plurality of data storage elements is switched on.

According to an embodiment, a three-dimensional neuromorphic device having multiple synapses per neuron includes a common gate that implements a single axon, and a plurality of data storage elements that implements each of a plurality of synapses, and the plurality of data storage elements have different physical structures for having different weights to store and process a plurality of weights in parallel, and the different physical structures include structures formed of different thicknesses or of different composition materials.

### Advantageous Effects of the Invention

To overcome the limitations, disadvantages and problems of the conventional neuromorphic devices described above, embodiments may propose a three-dimensional neuromorphic device that stores and processes data to which a plurality of weights are assigned in parallel, by mimicking a single axon and a plurality of synapses like a biological neuron.

In particular, the embodiments may propose a three-dimensional neuromorphic device that implements a single axon with a common gate and implements a plurality of synapses with a plurality of data storage elements, and allows the plurality of data storage elements to have different weights, by forming the plurality of data storage elements in different physical structures.

In addition, the embodiments propose a technique in which a three-dimensional neuromorphic device used as a post-neuron has a feedback function like a biological post-neuron while the three-dimensional neuromorphic device is used as a pre-neuron and a post-neuron, respectively.

Accordingly, the embodiments may propose a three-dimensional neuromorphic device used to implement an artificial intelligence system that can even derive self-determination by adapting to an unspecified environment like a human.

### DESCRIPTION OF THE DRAWINGS

FIG. 1 is a conceptual diagram for describing a three-dimensional neuromorphic device according to an embodiment.

FIG. 2 is a diagram illustrating a case in which a three-dimensional neuromorphic device is implemented based on a flash memory, according to an embodiment.

FIG. 3 is a diagram illustrating a case in which a three-dimensional neuromorphic device is implemented based on a Mott memory, according to an embodiment.

FIG. 4 is a diagram illustrating a case in which a three-dimensional neuromorphic device is implemented based on a phase change memory, according to an embodiment.

FIG. 5 is a diagram illustrating a case in which a three-dimensional neuromorphic device is implemented based on a resistance change memory, according to an embodiment.

FIG. 6 is a diagram for describing a neural network in which a three-dimensional neuromorphic device is used as a pre-neuron and a post-neuron, according to an embodiment.

### BEST MODE

Hereinafter, embodiments of the present disclosure will be described in detail with reference to the accompanying drawings. However, the present disclosure is neither limited nor restricted by the embodiments. Further, the same reference numerals in the drawings denote the same members.

Furthermore, the terminologies used herein are used to properly express the embodiments of the present disclosure, and may be changed according to the intentions of the user or the manager or the custom in the field to which the present disclosure pertains. Therefore, definition of the terms should be made according to the overall disclosure set forth herein.

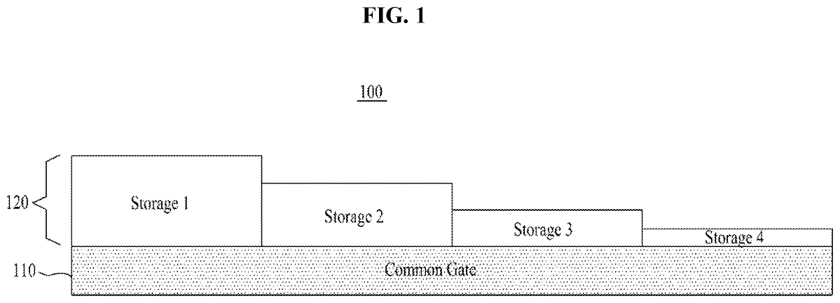

FIG. 1 is a conceptual diagram for describing a three-dimensional neuromorphic device according to an embodiment.

Referring to FIG. 1, a three-dimensional neuromorphic device 100 according to an embodiment includes a common gate 110 implementing a single axon of a biological neuron and a plurality of data storage elements 120 each implementing a plurality of synapses of the biological neuron. Hereinafter, the biological neuron refers to a neuron included in the nervous system of an actual human to be mimicked by the three-dimensional neuromorphic device 100.

Since the common gate 110 implements a single axon in the same way as a biological neuron, the common gate 110 may be responsible for the function of the axon of the neuron mimicked by the three-dimensional neuromorphic device 100 as it is. As an example, like a biological neuron that gives each weight to the plurality of synapses according to the magnitude of the signal input to the neuron, while being shared by the plurality of data storage elements 120, the common gate 110 may assign weights to each of the plurality of data storage elements 120 according to the magnitude of a signal input through the common gate 110.

In this case, when the common gate 110 gives each weight to the plurality of data storage elements 120, it may be to assign different weights to the plurality of data storage elements 120. This is based on characteristics of the plurality of data storage elements 120 described immediately below.

It is characterized in that the plurality of data storage elements 120 have different physical structures so as to have different weights. That is, the plurality of data storage elements 120 may have different weights through the different physical structures.

Accordingly, the plurality of data storage elements 120 may store and process data to which the plurality of weights are assigned in parallel, in response to the signal being introduced through the common gate 110, based on the characteristics having the different weights.

In this case, since the plurality of data storage elements 120 have the different weights through the different physical structures, when the signal is introduced through the common gate 110, the data with the different weights may be stored and processed in an array unit (integrally with respect to the plurality of data storage elements 120) using the different physical structures without separate processing.

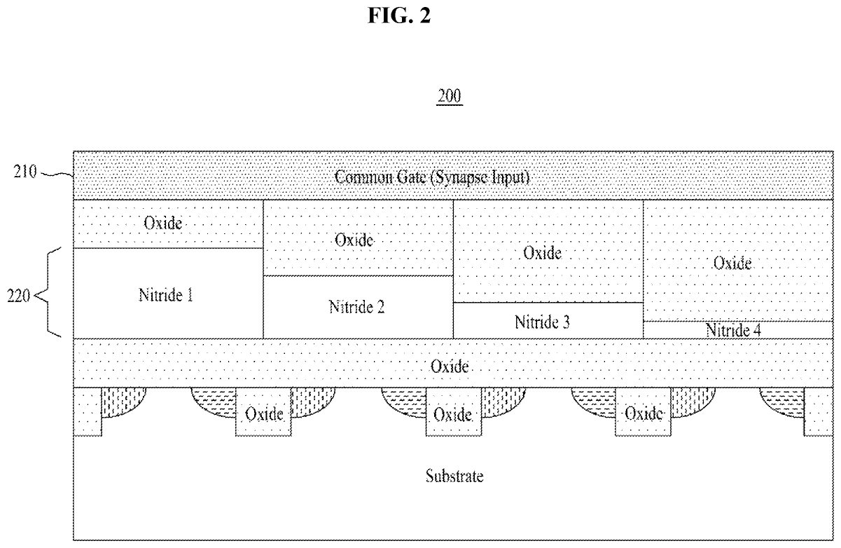

In this case, that the plurality of data storage elements 120 have the different physical structures may mean that the plurality of data storage elements 120 are formed not only with different thicknesses, but also with different composition materials as shown in the drawing. A detailed description thereof will be described with reference to FIGS. 2 to 4.

In the above, although the three-dimensional neuromorphic device 100 has been described as the structure including the common gate 110 and the plurality of data storage elements 120, since the device mimics the biological neuron, it is not limited thereto, and may further include a component implementing the dendrites. Since the components for implementing these dendrites are the same as in the case of the conventional three-dimensional neuromorphic device, additional description thereof will be omitted to avoid redundancy.

As described above, the three-dimensional neuromorphic device 100 according to an embodiment may store and process multi-valued analog values in parallel, thereby overcoming the limitations, disadvantages, and problems of the conventional neuromorphic device, by including the single common gate 110 that implements one axon like the biological neuron and the plurality of data storage elements 120 that implement the plurality of synapses to have the different weights,

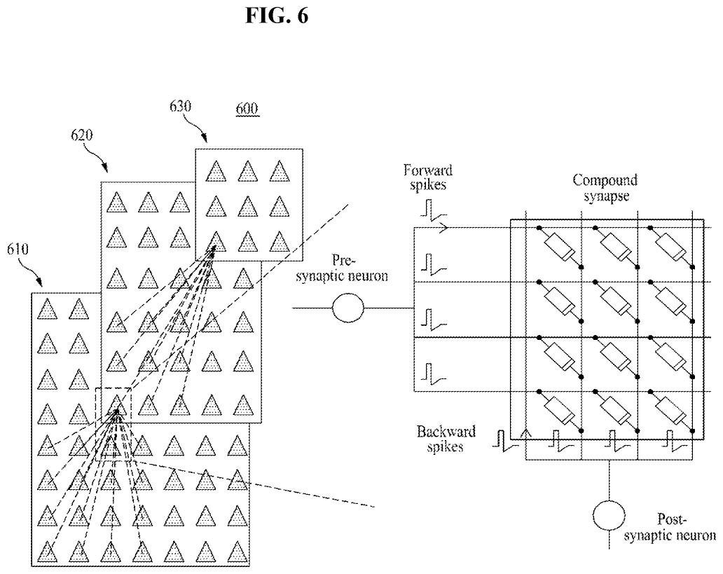

In addition, the three-dimensional neuromorphic device 100 may be used as a pre-neuron and a post-neuron, thereby forming the neural network in which pre-neurons and post-neurons are vertically intersected in a layer form. Accordingly, the neural network based on the three-dimensional neuromorphic device 100 may simultaneously perform input/output and learning of data, and may be utilized in the artificial intelligence system capable of real-time recognition and inference. A detailed description thereof will be described with reference to FIG. 6.

FIG. 2 is a diagram illustrating a case in which a three-dimensional neuromorphic device is implemented based on a flash memory, according to an embodiment.

Referring to FIG. 2, a flash memory-based three-dimensional neuromorphic device 200 includes a common gate 210 and a plurality of data storage elements 220, as described above with reference to FIG. 1. Hereinafter, since the plurality of data storage elements 220 means a nitride layer, which is a charge trap layer that acts as a floating gate FG among oxide layer-nitride layer-oxide layer (ONO) due to the characteristics of the flash memory base, it will be referred to as a plurality of nitride layers 220.

However, the three-dimensional neuromorphic device 200 may not only include the common gate 210 and the plurality of data storage elements 220, but may further include a substrate structure on which the ONO is formed. Since such the structure is the same as the conventional flash memory-based three-dimensional neuromorphic device, a detailed description thereof will be omitted to avoid redundancy.

The plurality of nitride layers 220 have different physical structures, similar to the plurality of data storage elements 120 described above with reference to FIG. 1. Accordingly, the plurality of nitride layers 220 have different capacitance values through different physical structures (e.g., as they have different thicknesses as illustrated in the drawing), and through this, may have different amounts of charge. Hereinafter, the plurality of nitride layers 220 are described as having different physical structures by being formed to have different thicknesses, but are not limited thereto, and may have different physical structures by being formed of different composition materials.

That is, the plurality of nitride layers 220 may store and process data with different weights in parallel (each of the plurality of nitride layers 220 becomes a synapse having a different weight) based on different physical structures (structures formed with different thicknesses), by adjusting the amount of each charge by FN tunneling (Fowler-Nordheim tunneling) depending on a value of the signal input through the common gate 210.

As in the above description, the flash memory-based three-dimensional neuromorphic device 200 may be used as the pre-neuron and the post-neuron, thereby forming the neural network in which pre-neurons and post-neurons are vertically intersected in the layer form. A detailed description thereof will be described with reference to FIG. 6.

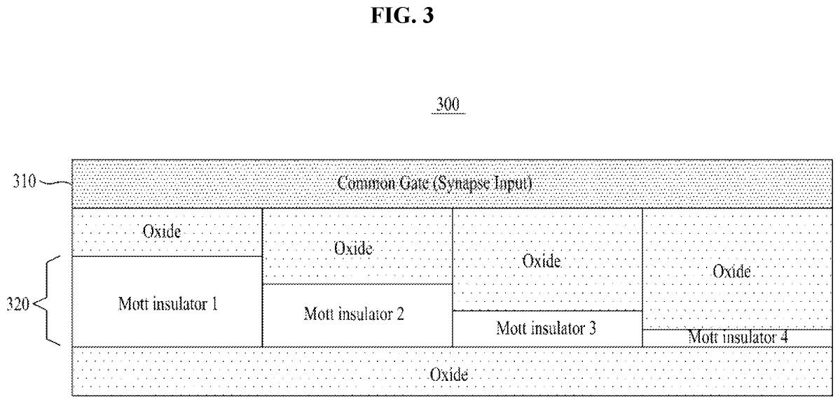

FIG. 3 is a diagram illustrating a case in which a three-dimensional neuromorphic device is implemented based on a Mott memory, according to an embodiment.

Referring to FIG. 3, a Mott memory-based three-dimensional neuromorphic device 300 includes a common gate 310 and a plurality of data storage elements 320, as described above with reference to FIG. 1. Hereinafter, since the plurality of data storage elements 320 mean a Mott insulator layer (e.g., VO₂, NbO₂, Nb₂O₅, HfO₂, SmNiO₃, etc.) that causes an Insulator-to-Metal phase transition (Mott transition) between an insulator and a metal among OMO (Oxide layer-Mott insulator layer-Oxide layer), due to the characteristics of the Mott memory, it will be referred to as a plurality of Mott insulator layers 320.

The plurality of Mott insulator layers 320 have different physical structures, similar to the plurality of data storage elements 120 described above with reference to FIG. 1. Accordingly, the plurality of Mott insulator layers 320 may have different phase transition characteristics (the phase transition characteristic is the characteristic associated with a degree to which a phase transition from an insulator to a metal occurs in response to a specific input pulse value) through the different physical structures (e.g., as it has different thicknesses as illustrated in the drawing), and thus may have different conductance values or different resistance values. In this case, the reason why the plurality of Mott insulator layers 320 have different phase transition characteristics is because they have different capacitance values due to the fact that the plurality of Mott insulator layers 320 have the different physical structures. Hereinafter, the plurality of Mott insulator layers 320 are described as having different physical structures by being formed to have different thicknesses, but are not limited thereto, and may have different physical structures by being formed of different composition materials.

That is, the plurality of Mott insulator layers 320 may store and process data with different weights in parallel (each of the plurality of Mott insulator layers 320 becomes a synapse having a different weight) based on different physical structures (structures formed with different thicknesses), by adjusting each conductivity or resistance value depending on a value of the signal input through the common gate 310. For example, the plurality of Mott insulator layers 320 may be weighted by a set pulse according to a value of a signal input through the common gate 310.

As in the above description, the Mott memory-based three-dimensional neuromorphic device 300 may be used as the pre-neuron and the post-neuron, thereby forming the neural network in which pre-neurons and post-neurons are vertically intersected in the layer form. A detailed description thereof will be described with reference to FIG. 6.

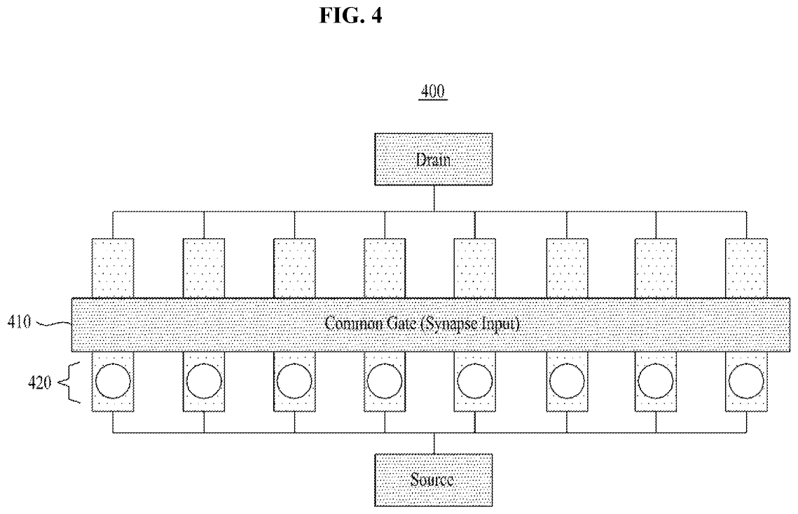

FIG. 4 is a diagram illustrating a case in which a three-dimensional neuromorphic device is implemented based on a phase change memory, according to an embodiment.

Referring to FIG. 4, a phase change memory-based three-dimensional neuromorphic device 400 includes a common gate 410 and a plurality of data storage elements 420, as described above with reference to FIG. 1. Hereinafter, the plurality of data storage elements 420 mean a phase change material (PCM) layer due to the characteristics of the phase change memory base, and will be referred to as a plurality of PCM layers 420.

The plurality of PCM layers 420 have different physical structures, similar to the plurality of data storage elements 120 described above with reference to FIG. 1. Accordingly, the plurality of PCM layers 420 may have different phase change characteristics (the phase change characteristic is the characteristic associated with a degree to which a phase between an amorphous state and a crystalline state changes in response to a specific input pulse value) through the different physical structures (e.g., as it is formed of different composition materials as illustrated in the drawing), and thus may have different resistance values.

Hereinafter, the plurality of PCM layers 420 are described as having different physical structures by being formed of different composition materials, but are not limited thereto, and may have different physical structures by being formed with different thicknesses.

That is, the plurality of PCM layers 420 may store and process data with different weights in parallel (each of the plurality of PCM layers 420 becomes a synapse having a different weight) based on different physical structures (structures formed of different composition materials), by adjusting each resistance value depending on a value of the signal input through the common gate 410.

As in the above description, the phase change memory-based three-dimensional neuromorphic device 400 may be used as the pre-neuron and the post-neuron, thereby forming the neural network in which pre-neurons and post-neurons are vertically intersected in the layer form. A detailed description thereof will be described with reference to FIG. 6.

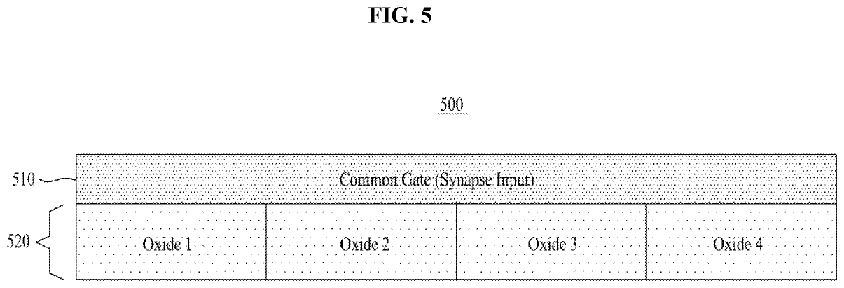

FIG. 5 is a diagram illustrating a case in which a three-dimensional neuromorphic device is implemented based on a resistance change memory, according to an embodiment.

Referring to FIG. 5, a resistance change memory-based three-dimensional neuromorphic device 500 includes a common gate 510 and a plurality of data storage elements 520, as described above with reference to FIG. 1. Hereinafter, the plurality of data storage elements 520 mean an oxide layer due to the characteristics of the resistance change memory base, and will be referred to as a plurality of oxide layers 520.

The plurality of oxide layers 520 have different physical structures, similar to the plurality of data storage elements 120 described above with reference to FIG. 1. Accordingly, the plurality of oxide layers 520 may have different resistance change characteristics (the resistance change characteristic is the characteristic associated with a degree to which the resistance or conductivity changes in response to a specific input pulse value) through the different physical structures (e.g., as it is formed of different composition materials as illustrated in the drawing), and thus may have different conductance values or different resistance values.

Hereinafter, the plurality of oxide layers 520 are described as having different physical structures by being formed of different composition materials, but are not limited thereto, and may have different physical structures by being formed with different thicknesses.

That is, the plurality of oxide layers 520 may store and process data with different weights in parallel (each of the plurality of oxide layers 520 becomes a synapse having a different weight) based on different physical structures (structures formed of different composition materials), by adjusting each resistance value or each conductance value depending on a value of the signal input through the common gate 510.

As in the above description, the resistance change memory-based three-dimensional neuromorphic device 500 may be used as the pre-neuron and the post-neuron, thereby forming the neural network in which pre-neurons and post-neurons are vertically intersected in the layer form. A detailed description thereof will be described with reference to FIG. 6.

FIG. 6 is a diagram for describing a neural network in which a three-dimensional neuromorphic device is used as a pre-neuron and a post-neuron, according to an embodiment. Hereinafter, the neural network is described as composed of the phase change memory-based three-dimensional neuromorphic devices, but is not limited thereto, and the case in which the neural network is composed of the flash memory-based three-dimensional neuromorphic devices, the Mott memory-based three-dimensional neuromorphic devices, or the resistance change memory-based three-dimensional neuromorphic devices may also be described in the same way.

Referring to FIG. 6, a neural network 600 according to an embodiment is characterized in that the three-dimensional neuromorphic device described above with reference to FIGS. 1 to 5 is used as the pre-neuron and the post-neuron in layers.

For example, while the neural network 600 is composed of an input layer 610, a hidden layer 620, and an output layer 630, each of the three-dimensional neuromorphic devices included in the input layer 610 may be used as a pre-neuron for each of the three-dimensional neuromorphic devices included in the hidden layer 620, and each of the three-dimensional neuromorphic devices included in the hidden layer 620 may be used as a post-neuron for each of the three-dimensional neuromorphic devices included in the input layer 610. As in the above description, each of the three-dimensional neuromorphic devices included in the hidden layer 620 may be used as a pre-neuron for each of the three-dimensional neuromorphic devices included in the output layer 630, and each of the three-dimensional neuromorphic devices included in the output layer 630 may be used as a post-neuron for each of the three-dimensional neuromorphic devices included in the hidden layer 620.

As such, the neural network 600 is formed in a structure in which pre-neurons and post-neurons are vertically intersected in a layer form, thereby mimicking the human nervous system.

In particular, the neural network 600 may implement a memory enhancement mechanism or a forgetting mechanism similar to the human brain by allowing the three-dimensional neuromorphic device used as a post-neuron in each layer to have a feedback function like a biological post-neuron.

Unlike the human brain, since the neural network 600 that mimics the nervous system is based on a non-volatile memory, there is no need to separately apply the memory enhancement mechanism. Accordingly, the neural network 600 may implement the memory enhancement mechanism only with a simple output function. For example, when it is necessary to store the same data as data already stored in a plurality of synapses (PCM layers) included in the three-dimensional neuromorphic device used as a pre-neuron (i.e., when the memory enhancement is required), the neural network 600 may only perform an output function in response to the three-dimensional neuromorphic device used as a post-neuron connected through a plurality of synapses (PCM layers) being switched off. For a more specific example, when it is necessary to strengthen memory for data stored in synapses (PCM layers) of the three-dimensional neuromorphic device used as a pre-neuron included in the input layer 610, the three-dimensional neuromorphic device used as a pre-neuron included in the input layer 610 may output data stored in the PCM layers implementing synapses (PCM layers) in a state in which weights are not changed by generating a forward pulse as the three-dimensional neuromorphic device used as a post-neuron included in the hidden layer 620 is switched off. When it is necessary to store additional data in the PCM layers of the three-dimensional neuromorphic device used as pre-neuron included in the input layer 610, the three-dimensional neuromorphic device used as a pre-neuron included in the input layer 610 may generate a forward pulse for additional data and may store data including the additional data in the PCM layers.

In case of forgetting mechanism (when it is necessary to delete weighted data stored in a plurality of synapses (PCM layers) included in the three-dimensional neuromorphic device used as a pre-neuron), the neural network 600 may delete the weighted data stored in a plurality of synapses (PCM layers) (inhibiting weighting in each of the PCM layers) in response to a backward pulse as the three-dimensional neuromorphic device used as a post-neuron connected through a plurality of synapses (PCM layer) is switched on. For a more specific example, when it is necessary to delete data stored in the PCM layers of the three-dimensional neuromorphic device used as a pre-neuron included in the input layer 610, the neural network 600 may delete weighted data stored in the PCM layers by generating a backward pulse as the three-dimensional neuromorphic device used as a post-neuron included in the hidden layer 620 connected to the PCM layers of the input layer 610 is switched on.

When the neural network 600 is based on the flash memory-based three-dimensional neuromorphic device, weighted data stored in the ONO layers may be deleted as the three-dimensional neuromorphic device used as a post-neuron injects holes into the PCM layers of the three-dimensional neuromorphic device used as a pre-neuron using a backward pulse. When the neural network 600 is based on the flash memory-based three-dimensional neuromorphic device, weighted data stored in the OMO layers may be deleted as the three-dimensional neuromorphic device used as a post-neuron injects holes into the OMO layers of the three-dimensional neuromorphic device used as a pre-neuron using a backward pulse. When the neural network 600 is based on the flash memory-based three-dimensional neuromorphic device, weighted data stored in the OMO layers may be deleted as the three-dimensional neuromorphic device used as a post-neuron injects holes into the OMO layers of the three-dimensional neuromorphic device used as a pre-neuron using a backward pulse.

As such, the neural network 600 may implement the memory enhancement mechanism or the forgetting mechanism for data storage elements of the three-dimensional neuromorphic device used as a pre-neuron by using the switch-on or switch-off of the three-dimensional neuromorphic device used as a post-neuron as the feedback function.

While a few embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned elements, such as systems, structures, devices, or circuits, are combined or coupled in different forms and modes than as described above or be substituted or switched with other components or equivalents.

Therefore, other implements, other embodiments, and equivalents to claims are within the scope of the following claims.

### INDUSTRIAL APPLICABILITY

The present disclosure relates to a three-dimensional neuromorphic device that mimics a neuron composing a human nervous system.

1. A three-dimensional neuromorphic device having multiple synapses per neuron, comprising:
a common gate configured to implement a single axon; and
a plurality of data storage elements configured to implement each of a plurality of synapses, and
wherein the plurality of data storage elements have different physical structures.

2. The three-dimensional neuromorphic device of claim 1, wherein the plurality of data storage elements have different weights through the different physical structures.

3. The three-dimensional neuromorphic device of claim 2, wherein the plurality of data storage elements having the different weights store and process data to which a plurality of weights are assigned in parallel, in response to a signal flowing through the common gate.

4. The three-dimensional neuromorphic device of claim 1, wherein the plurality of data storage elements have the different physical structures by being formed of different thicknesses or of different composition materials.

5. The three-dimensional neuromorphic device of claim 1, wherein each of the plurality of data storage elements is a nitride layer of ONO (Oxide layer-Nitride layer-Oxide layer) in a flash memory.

6. The three-dimensional neuromorphic device of claim 5, wherein the plurality of nitride layers have different amounts of charge depending on having different capacitance values through different physical structures.

7. The three-dimensional neuromorphic device of claim 1, wherein each of the plurality of data storage elements is a Mott insulator layer of OMO (Oxide layer-Mott insulator layer-Oxide layer) in a Mott memory.

8. The three-dimensional neuromorphic device of claim 7, wherein the plurality of Mott insulator layers have different conductivities or different resistance values, depending on having different phase transition characteristics (Insulator-to-Metal Phase Transition: Mott Transition) through different physical structures.

9. The three-dimensional neuromorphic device of claim 1, wherein each of the plurality of data storage elements is a phase change material (PCM) layer in a phase change memory.

10. The three-dimensional neuromorphic device of claim 9, wherein the plurality of PCM layers have different resistance values depending on having different phase change characteristics through different physical structures.

11. The three-dimensional neuromorphic device of claim 1, wherein each of the plurality of data storage elements is an oxide layer in a resistance change memory.

12. The three-dimensional neuromorphic device of claim 11, wherein the plurality of oxide layers have different resistance values or different conductance values depending on having different resistances or different conductance change characteristics through different physical structures.

13. The three-dimensional neuromorphic device of claim 1, wherein the three-dimensional neuromorphic device is used as a pre-neuron and a post-neuron connected through at least one synapse of the pre-neuron and the plurality of synapses.

14. The three-dimensional neuromorphic device of claim 13, wherein the three-dimensional neuromorphic device used as the pre-neuron, when it is necessary to store the same data as previously stored data in the plurality of data storage elements included in the three-dimensional neuromorphic device used as the pre-neuron, performs only an output function in response to the three-dimensional neuromorphic device used as the post-neuron connected through the plurality of data storage elements being switched off.

15. The three-dimensional neuromorphic device of claim 13, wherein the three-dimensional neuromorphic device used as the pre-neuron, when it is necessary to delete weighted data stored in the plurality of data storage elements included in the three-dimensional neuromorphic device used as the pre-neuron, deletes the weighted data stored in the plurality of data storage elements, in response to a backward pulse as the three-dimensional neuromorphic device used as the post-neuron connected through the plurality of data storage elements is switched on.

16. A three-dimensional neuromorphic device having multiple synapses per neuron, comprising:
a common gate configured to implement a single axon; and
a plurality of data storage elements configured to implement each of a plurality of synapses, and
wherein the plurality of data storage elements have different physical structures for having different weights to store and process a plurality of weights in parallel, and
wherein the different physical structures include structures formed of different thicknesses or of different composition materials.
